(19) United States
(12) Patent Application Publication
(10) Pub. No.: US 2016/0237973 A1
(43) Pub. Date: Aug. 18, 2016

(54) Pressure Control Vavle

(71) Applicant: CONTINENTAL AUTOMOTIVE GMBH, Hannover (DE)

(72) Inventors: Matthias Bleeck, Pentling (DE); Rainer Weber, Regensburg (DE); Bernd Woellisch, Chamerau (DE)

(73) Assignee: Continental Automotive GmbH, Hannover (DE)

(21) Appl. No.: 15/029,710

(22) PCT Filed: Oct. 15, 2014
(86) PCT No.: PCT/EP2014/072091

§ 371 Date: Apr. 15, 2016

(30) Foreign Application Priority Data
Oct. 15, 2013 (DE) 10 2013 220 877.4

(51) Int. Cl. F02M 63/00; F16K 31/06

(52) U.S. Cl. CPC F02M 63/0022; F16K 31/0675

(57) ABSTRACT

The present disclosure describe a valve comprising a control unit for controlling a valve element, an electromagnet, and a valve element. The control unit may include an armature group. The electromagnet may include a coil and a pole core. The armature group may include a magnet armature moved by the electromagnet, an intermediate element, and a control pin for controlling the valve element. The control pin may be connected to the magnet armature via the intermediate element and moved together with the magnet armature. The intermediate element may be resilient and couple the control pin resiliently to the magnet armature.

### CROSS-REFERENCE TO RELATED APPLICATIONS

This application is a U.S. National Stage Application of International Application No. PCT/EP2014/072091 filed Oct. 15, 2014, which designates the United States of America, and claims priority to DE Application No. 10 2013 220 877.4 filed Oct. 15, 2013, the contents of which are hereby incorporated by reference in their entirety.

### TECHNICAL FIELD

The present disclosure relates to a valve and, in particular, a pressure control valve for a pressure circuit and, as one example, an accumulator injection system for internal combustion engines of motor vehicles.

### BACKGROUND

Known pressure control valves may have a switching magnet which opens and/or closes a valve element. Noise and mechanical wear can occur as a result of the mechanical pulses of the switching magnet in customary valves. In order to avoid the noise, a reduction in the mass of the moving components or a reduction in the magnetic forces are preferred. In addition, hardened materials are used in order to avoid wear.

### SUMMARY

In the present disclosure, a valve is taught which may have a reduced noise development and/or lower wear.

According to some embodiments, a valve has a control unit for controlling a valve element. The control unit has an electromagnet and an armature group. In particular, the valve may be a solenoid valve, in which the electromagnet, together with the armature group of the control unit, can bring about opening and/or closing of the valve element which can have, for example, a valve needle or valve flap.

According to some embodiments, the electromagnet has a coil and a pole core, it being possible for the coil to surround the pole core. The armature group has a magnet armature which can be moved by means of the electromagnet. Furthermore, the armature group has an intermediate element and a control pin for controlling the valve element. The control pin is connected to the magnet armature via the intermediate element and can be moved together with the magnet armature, the intermediate element being of resilient configuration and coupling resiliently in the control pin to the magnet armature.

In some embodiments, the armature group, having the magnet armature, the intermediate element and the control pin, can be attracted to the pole core by way of the magnetic force in the case of energization of the coil. Here, the pole core serves as a stop for the magnet armature, which stop limits the movement of the magnet armature and therefore of the armature group in the direction of the pole core. If the magnet armature were directly connected rigidly to the control pin or if the intermediate element were of rigid configuration, the entire armature group would contribute to the pulse when the armature group comes into contact with the pole core. By virtue of the fact that the intermediate element is of resilient configuration, the effective mass of the elements of the armature group which come into contact with the pole core in the case of energization of the coil is reduced, because part of the pulse can be absorbed by way of the intermediate element of resilient configuration.

According to some embodiments, the control unit has a spring which attempts to press the magnet armature and the pole core apart from one another. In particular, the spring can be arranged in an opening of the armature and can be arranged between the magnet armature and the pole core in such a way that the spring presses against the intermediate element and against the pole core. If the energization of the coil is switched off, the spring presses the armature group in a direction away from the pole core. In order to limit the movement of the armature group in the direction away from the pole core, the control pin can have a stop region which is pressed against a stop in a switched off state of the electromagnet. In some embodiments, the stop region can be configured as a collar-shaped part region of the control pin which faces away from the magnet armature. As has already been described above in conjunction with the switched on state of the electromagnet, in the case where the control pin and the magnet armature are directly connected rigidly to one another or where the intermediate element is of rigid configuration, all elements of the armature group would contribute to the pulse which is exerted on the stop. Part of the pulse can be absorbed by way of the intermediate element as a result of the intermediate element described here which is of resilient configuration, with the result that the pulse between the control pin and the stop can be reduced.

As a result of the intermediate element of resilient configuration and its property of reducing pulses between the magnet armature and the pole core and between the control pin and the stop, the noise generation and the wear in the control unit can be reduced, in particular, at the stop and at the pole core and at the control pin.

According to some embodiments, the intermediate element has a disk shape. There can be a central opening in the center of the disk-shaped intermediate element, through which opening the control pin protrudes and in which opening the control pin is fastened. The edge of the disk-shaped intermediate element can be fastened at least in regions to the magnet armature. Furthermore, the intermediate element can have cutouts. As a result of the arrangement of cutouts, webs or arms can be configured between the cutouts in the intermediate element, which webs or arms can form levers, by way of which the resilient action of the intermediate element can be influenced in a targeted manner. The intermediate element can be made from a resilient steel or can have a resilient steel of this type. Here, steel types are generally possible which make the elastic deformation possible, for example spring steel.

According to some embodiments, the control pin has a noise-damping and/or wear-resistant material. For example, the control pin can have a rubber coating at least in the region of the collar-shaped part region which is pressed against the stop in the switched off state of the electromagnet. Furthermore, it is also possible that the control pin has carbon fibers at least partially or else over its entire length, which carbon fibers have particularly advantageous noise-damping and wear-resistant properties.

### BRIEF DESCRIPTION OF THE DRAWINGS

Further advantages, advantageous embodiments and developments result from the exemplary embodiments which are described in the following text in conjunction with the figures, in which:

FIG. 1 shows a diagrammatic sectional illustration of a detail of a valve according to one exemplary embodiment, and

FIGS. 2A and 2B show diagrammatic illustrations of intermediate elements according to further exemplary embodiments.

### DETAILED DESCRIPTION

In the exemplary embodiments and figures, identical, similar or identically acting elements can be provided in each case with the same designations. The elements which are shown and their proportions to one another are not to be considered to be true to scale; rather, individual elements, such as layers, components, structural elements and regions, can be shown on an exaggeratedly large scale for improved visualization and/or for improved understanding.

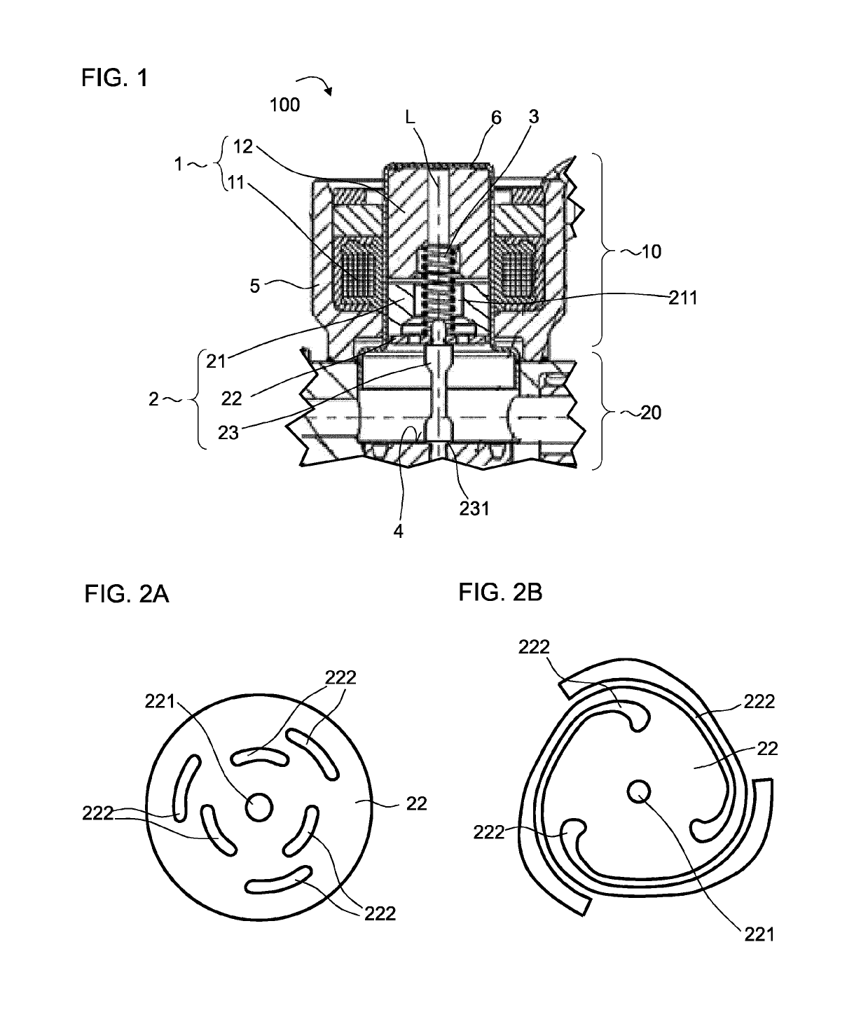

FIG. 1 shows a detail of a valve 100 which is configured as a solenoid valve and can be, for example, a pressure control valve for controlling a pressure of a fluid in a pressure circuit. For example, the valve 100 can be used for an accumulator injection system for internal combustion engines.

The valve 100 has a control unit 10 and a valve element 20. The valve element 20 which is shown only in details can have, for example, a valve needle or a valve flap which can be controlled by way of a control pin. Valve elements of this type are known to a person skilled in the art and will not be described further here. Furthermore, electrical connectors and plugs for electric contacting and actuation of the valve 100 are also not shown.

The control unit 10 of the valve 100 has an electromagnet 1 and an armature group 2. The control unit 10 is therefore configured as an electromagnetic actuator unit. The electromagnet 1 has a coil 11, in particular a magnet coil, which is arranged in a housing 5. Furthermore, the electromagnet 1 has a pole core 12.

The armature group 2 has a magnet armature 21 which, together with the pole core 12, is arranged in a cup-shaped housing 6. There is an air gap between the pole core 12 and the magnet armature 21 in the switched off state of the coil 11. The housing 5 with the coil 11 is pushed over the cup-shaped housing 6 in a direction along the longitudinal axis L which is indicated using dashed lines. The coil 11, the housing 5, and the cup-shaped housing 6 with the pole core 12 and the magnet armature 21 together form an electromagnetic circuit. The latter attempts to reduce the air gap between the pole core 12 and the magnet armature 21 in the case of energization of the coil 11, with the result that the magnet armature 21 is pulled against the pole core 12.

Furthermore, the armature group 2 has an intermediate element 22 which is connected to the magnet armature 21. Furthermore, the intermediate element 22 is connected to a control pin 23 which protrudes into the valve element 20. For example, the control pin is connected to a valve needle or valve flap of the valve element 20 in such a way that the valve element 20 can be controlled, that is to say opened and closed, by way of the control pin 23. The control pin 23 is coupled to the magnet armature 21 by way of the intermediate element 22 and can thus be moved together with the magnet armature 21. The intermediate element 22 is of resilient configuration and therefore couples the control pin 23 resiliently to the magnet armature 21. To this end, the resilient intermediate element 22 has, in particular, a resilient steel which is capable of being deformed elastically. For example, the intermediate element 22 can be made from spring steel.

Furthermore, the control unit 10 has a spring 3 which attempts to press the magnet armature 21 and the pole core 12 apart from one another. In particular, the spring 3 acts counter to the movement of the magnet armature 21 in the case of energization of the coil 11. If the energization of the coil 11 is switched off, the spring 3 presses the magnet armature along the longitudinal axis L away from the pole core 12.

The magnet armature 21 has, in particular, an armature opening 211, through which the control pin 23 protrudes at least partially. Furthermore, the spring 3 is also arranged in the armature opening 211 and presses against the pole core 12 and the intermediate element 22.

The intermediate element 22 is of disk-shaped configuration and has a central opening, through which the control pin 23 protrudes. In the region of the central opening, the control pin 23 is connected, for example welded, to the intermediate element 22. Furthermore, the intermediate element 22 is connected, for example welded, to the magnet armature 21 at an edge region. In particular, the intermediate element 22 can be connected to the magnet armature 21 in a punctiform manner in edge regions or else in an entire circumferential edge region.

The control pin 23 has a stop region in the form of a collar-shaped part region 231 which faces away from the magnet armature 21 and, in a switched off state of the electromagnet 1, is pressed against a stop 4 by way of the action of the spring 3. The stop 4 is formed by way of a part of the valve element 20, into which the control pin 23 protrudes. For example, the stop 4 can be formed by way of a part of a valve housing, into which the control pin protrudes through an opening. In this case, the collar-shaped part region 231 can be formed by way of a step-shaped cross-sectional change of the control pin 23, whereas the stop 4 is formed by way of the edge which delimits the opening, through which the control pin 23 protrudes.

In order to open and close the valve 100, the coil 11 is energized and the energization is switched off, respectively. In the case of energization of the coil 11, the armature group 2 is attracted toward the pole core 12 by way of the magnetic force counter to the spring 3, as described above, whereas, in the case of switched off energization, the spring 3 presses the armature group 2 against the stop 4. The respective pulse, with which the magnet armature 21 comes into contact with the pole core 12 or the collar-shaped part region 231 of the control pin 23 comes into contact with the stop 4, can be reduced in the case of the valve 100 by way of the intermediate element 22 of resilient configuration, since the intermediate element 22 of resilient configuration can in each case absorb a part of the pulse by way of an elastic deformation in the case of both movements. As a result, both noise development and wear at the pole core 12 and at the magnet armature 21 and at the control pin 23 and at the stop 4 can be reduced in comparison with rigid fastening of the control pin 23 to the magnet armature 21.

Furthermore, if the control pin 23 has a noise-damping and/or wear-resistant material, for example carbon fibers or a rubber coating between the pin 23 and the stop 4, the valve may have reduced noise development and/or wear.

FIGS. 2A and 2B show exemplary embodiments for the resilient intermediate element 22. In particular, the intermediate element 22 has a disk-shaped configuration. The control pin 23 protrudes through a central opening 221, as shown in FIG. 1, and is connected in the region of the central opening 221 to the intermediate element 22, for example by way of welding. The edge region of the intermediate element 22 is connected to the magnet armature 21, as shown in FIG. 1, for example likewise by way of welding.

As shown in FIG. 2A, the intermediate element 22 has, furthermore, cutouts 222 which are arranged around the central opening 221 and therefore around the control pin 23. The cutouts 222 result in geometries with webs or arms which form levers which can be deformed elastically. As a result, the resilient action of the intermediate element 23 can be influenced in a targeted manner.

The intermediate element 22 according to the embodiment of FIG. 2B has cutouts which extend in each case as far as the edge region of the intermediate element 22, with the result that spiral arms are formed which are separated from one another by way of the cutouts 222. In comparison with the embodiment of FIG. 2A, said spiral arms form longer levers which can be deformed elastically, as a result of which the above-described reduction in the pulses between the magnet armature 21 and the pole core 12 and between the control pin 23 and the stop 4 can be reinforced. In particular, the resilient properties of the intermediate element 23 can be influenced in a targeted manner by way of the material, the material thickness, the size of the cutouts and the position of the cutouts. For example, depending on the spring property in the embodiments which are shown, the intermediate element 22 can have a thickness of greater than or equal to 0.1 mm and less than or equal to 3 mm or even more than 3 mm.

The invention is not restricted by the description using the exemplary embodiments to the latter. Rather, the invention comprises every novel feature and every combination of features, which includes, in particular, every combination of features in the patent claims, even if said feature or said combination itself is not specified explicitly in the patent claims or exemplary embodiments.

What is claimed is:

1. A valve comprising:
a control unit for controlling a valve element,
the control unit including an electromagnet and an armature group,
the electromagnet including a coil and a pole core,
the armature group including a magnet armature moved by the electromagnet, an intermediate element, and a control pin for controlling the valve element,
the control pin connected to the magnet armature via the intermediate element and moved together with the magnet armature, and
the intermediate element being resilient and coupling the control pin resiliently to the magnet armature.

2. The valve as claimed in claim 1, further comprising:
the intermediate element being of disk-shaped configuration, and
the control pin protruding through a central opening of the intermediate element and being connected to the intermediate element in the region of the central opening.

3. The valve as claimed in claim 1, further comprising the intermediate element connected to the magnet armature in an edge region.

4. The valve as claimed in claim 1, further comprising the intermediate element having cutouts arranged around the control pin.

5. The valve as claimed in claim 4, further comprising the intermediate element having spiral arms which are separated from one another by way of the cutouts.

6. The valve as claimed in claim 1, further comprising the intermediate element made from resilient steel.

7. The valve as claimed in claim 1, further comprising the magnet armature having an armature opening, through which the control pin protrudes and in which a spring is arranged exerting a force to press the magnet armature and the pole core apart from one another.

8. The valve as claimed in claim 7, further comprising the spring pressing against the pole core and against the intermediate element.

9. The valve as claimed in claim 1, further comprising the control pin having a collar shaped part region facing away from the magnet armature, and
the control pin impressed with the collar-shaped part region against a stop in a switched off state of the electromagnet.

10. The valve as claimed in claim 1, further comprising the control pin including carbon fibers.
